(19) United States
(12) Patent Application Publication
(10) Pub. No.: US 2004/0264087 A1
(43) Pub. Date: Dec. 30, 2004

(54) Transient protector for wireless communications equipment

(76) Inventor: Roger S. Bishop, Dayton, NV (US)

Correspondence Address: ROGER BISHOP, 203 GOLD CREEK DR., DAYTON, NV, 89403, US

(21) Appl. No.: 10/878,258

(22) Filed: Jun. 28, 2004

Related U.S. Application Data
(60) Provisional application No. 60/484,379, filed on Jun. 30, 2003.

(51) Int. Cl. H02H 9/00

(52) U.S. Cl. 361/91.1

(57) ABSTRACT

A transient protector for protecting wireless communications equipment that includes but is not limited to broadband wireless access (BWA) and wireless local area networks (WLAN) from damage by high energy transient events.

A transient protector wherein the means improved signal coupling of high speed, complex data or, modulated or un-modulated radio frequency, electrical power and telephony signals, wherein the means reduce signal distortion of high speed, complex data or, modulated or un-modulated radio frequency, electrical power and telephony signals, wherein the means of improved isolation of transient energy, wherein the means of reduce transient energy through-put.

The inventive device includes an input; an output; a first apparatus comprising of signal conditioning devices; a second apparatus comprising of transient conditioning devices; a first set of conductors wherein conductors couple the input to the first apparatus, wherein conductors couple the input to the second apparatus; a second set of conductors wherein conductors couple the output to the first apparatus, wherein conductors couple the output to the second apparatus.

### REFERENCES CITED [REFERENCED BY]

U.S. Patent Documents

| | | |
|---|---|---|
| 6,342,998 B1 | January 2002 | Bencivenga, Robert |
| 6,385,030 B1 | May 2002 | Beene, Gerald W. |
| 6,421,220 B1 | July 2002 | Kobsa, Peter |

### CROSS REFERENCE TO RELATED APPLICATION

This application relates to and claims priority from U.S. Provisional Patent Application Ser. No. 60/484379 filed Jun. 30, 2003, entitled “TRANSIENT PROTECTOR FOR WIRELESS COMMUNICATIONS EQUIPMENT,” which is herein incorporated by reference for all purposes.

### BACKGROUND OF THE INVENTION

1. Field of the Invention

The present invention relates generally to transient protection device and more specifically, as it relates to a transient protector for wireless communications equipment to provide high energy transient protection to electronics processing high speed, complex data and modulated radio frequency signals while providing improved signal coupling and reduced signal distortion.

Another purpose is for providing high energy transient protection of electrical power equipment while providing improved coupling power losses.

Another purpose is for providing high energy transient protection of telephony equipment while providing improved signal coupling and reduced signal distortion.

2. Description of the Prior Art

It can be appreciated that transient protection device have been in use for years. Conventional transient protection devices are embodied in prior art similar to FIG. 1 and FIG. 2 that provide various levels of protection to data, telephony, communication, and power supply equipment against undesirable transient events.

While these devices may be suitable for the particular purpose to which they address, these devices are generally not suitable for providing high energy transient protection while also providing low signal coupling losses and low signal distortion to broadband wireless access (BWA) and wireless local area network (WLAN) equipment that utilize high speed data, modulated radio frequency signals, electrical power and telephony.

The main problem with conventional transient protection devices similar to the prior art of FIG. 1 and FIG. 2, lies with undesirable signal coupling losses and signal distortion of complex high speed data or modulated radio frequency signals used in BWA and WLAN applications. Another problem convention transient protection devices is insufficient suppression of transient voltage and energy levels developed under lightning or other similar high energy transient events to levels tolerable by much of the BWA and WLAN equipment currently in application.

FIG. 1 is an embodiment of prior art, representing a low capacitance surge protector that is suitable for high speed data. FIG. 1 employs two gas discharge tubes 50, 52 and four low capacitance TVS diodes 150, 152, 154, 156 electrically coupled between two electrical transmission lines 12, 14 respectively and common ground 506. Each electrical transmission line 12, 14 of the surge protector possess two electrical ports 90, 92 and 94, 96 respectively that couple high speed data or, telephony signals between electronic equipment such as computers or, telephony equipment through the surge protector. Because the gas discharge tubes 50, 52 possess low capacitance, the typical value of which is 2 pico-Farads and the TVS diodes 150, 152, 154, 156 also possess low capacitance, the typical value of which is between 5 to 20 pico-Farad, there is very low coupling losses and signal distortion as high speed data is coupled through the surge protector, between electrical transmission lines ports 90, 92 and 94, 96 respectively. Turning to the transient performance of FIG. 1, as the leading edge of a low energy level transient impulse such as a voltage spike coupled from a neighboring power line is introduced to either electrical transmission lines 12, 14 and if the voltage magnitude of the transient impulse is greater than the breakdown voltage of the TVS diodes 150, 152 and 154, 156 respectively, the TVS diodes 150, 152, 154 and 156 respectively will begin to couple the transient energy from the incident transient impulse to common ground 506, thereby limiting the voltage magnitude of the transient impulse between either of the electrical transmission lines 12, 14 and common ground 506 within a few pico-Seconds after the incident transient impulse has been introduced into either of the electrical transmission lines 12, 14. The incident transient impulse voltage that is coupled between either or, both of the electrical transmission lines 12, 14 respectively may possess a voltage level great enough to ionize the gas within the gas discharge tubes 50, 52 that are couple between transmission lines 12, 14 respectively and common ground 506, thus changing the state of the gas discharge tubes 50, 52 from a non-conducting to conducting state thereby aiding the TVS diodes 150, 152, 154, 156 to couple transient energy from either electrical transmission line 12, 14 to common ground 506. However, a problematic characteristic of gas discharge tubes in general, is that the voltage level required to change the state of the gas tube from a non-conducting to conducting state is a function of the applied change in voltage across the gas discharge tube terminals verses time (dV/dt). Hence, in applications such as BWA and WLAN where long lengths of high impedance electrical transmission lines are used to electrically couple to the surge protector ports 90, 92 and 94, 96 respectively and where there exists a strong likelihood of high energy transient events such as lightning and where this transient energy is either directly or, indirectly coupling into either electrical transmission lines 12, 14 there exists the likelihood that the gas discharge tubes 50, 52 will not change from a non-conducting state to a conducting state. Furthermore, should the gas discharges tubes 50, 52 not change from a non-conducting state to a conducting state during a transient event, there exists the likelihood of destroying the TVS diodes 150, 152, 154, 156 due to excessive transient current being coupled from either of the electrical transmission lines 12, 14 through the TVS diodes 150, 152, 154, 156 respectively to common ground. 506. To resolve the transient performance inadequacies of prior art similar to FIG. 1, prior art similar to FIG. 2 has been employed.

FIG. 2 is a second embodiment of prior art representing a data equipment surge protector capable of coupling high levels of transient energy to a common ground 506. The surge protector of FIG. 2 possess four electrical ports 90, 92 and 94, 96 that electrically couples electrical transmission lines 12, 14 respectively between electronic equipment such as computers and, telephony equipment. The electrical transmission lines 12, 14 are electrically coupled to inductors 30, 36 respectively that are electrically coupled to gas discharge tubes 50, 52 respectively that are electrically coupled to common ground 506. Inductor 30 and gas discharge tube 50 are electrically coupled 40 to inductor 32. Inductor 32 is electrically coupled 41 to varistors 140, 142 and resistor 130. Resistor 130 is electrically coupled 42 to TVS diodes 150, 152. Inductor 36, gas discharge tube 52, inductor 34, varistors 144, 146, resistor 132 and TVS diodes 154, 156 are electrically coupled in a similar manner. As high speed data is introduced between lines 12, 14, the inductors 30,36 offer high impedance to the data signals preventing much of the signal from being undesirably coupled to the remaining components yet offering a low impedance electrical path to transient energy to allow much of the energy to be conditioned by the remaining components.

However, all inductors such as those used in prior art, possess undesirable parasitics that tend to distort high speed data signals and increase coupling losses. Hence, prior art similar to FIG. 2 would not be suitable for many BWA and WLAN applications due to the undesirable effects of high coupling losses and signal distortion between electrical ports 90, 92 and 94, 96 respectively due to the surge protection circuitry.

Turning to the transient performance of FIG. 2,. As the leading edge of a high energy transient impulse similar to lightning is introduced into either electrical transmission line 12, 14 the transient energy is coupled through inductor 30, 36 respectively with little coupling loss within the inductors 30, 36. If the dV/dt of the transient impulse is sufficient to ionize the gas within the gas discharge tubes 50, 52, respectively, the gas discharge tubes 50, 52 will change from a non-conducting state to a conducting state thereby coupling a large portion of the transient energy to common ground 506. Residual transient energy present across gas discharge tubes 50, 52 will be coupled through inductors 32, 34 respectively. The voltage developed across inductors 32, 34 is a function of the inductance value and the rate of change of transient current coupled through inductors 32, 34 verse time (Ldi/dt). As the residual transient energy is coupled though inductors 32, 34, the varistors remain in a non-conducting state until the clamping voltage of the varistor is reached at which point the varistors 140, 142 and 144, 146 respectively enter a conducting state coupling much of the residual energy to common ground 506. The remaining residual energy present is coupled through resistors 130, 132 respectively that act to limit the amount of current that the TVS diodes 150, 152 and 154, 156 respectively must couple to common ground 506. As the remaining residual energy that is coupled through the resistors 130, 132, respectively the TVS diodes 150, 152 and 154, 156 respectively remain in a non-conductive state until the voltage across the TVS diodes 150, 152 and 154, 156 respectively reach the breakdown voltage of the diodes at which point the TVS diodes 150, 152 and 154,156 respectively enter a conductive state coupling most of the remaining residual energy to common ground 506. While prior art similar to FIG. 2 performs extremely well at coupling tremendous amounts of transient current (upwards to 20 kA), prior art similar to FIG. 2 possesses the problematic characteristic of allowing very high levels of voltage and energy to pass through the surge protector to BWA and WLAN equipment. These levels may be as high as 1 kilo-Volt and 200 milli-Joules.

While prior art similar to FIG. 2 may be suitable in applications whereby the equipment can handle these levels without damage, much of the data and communication equipment used in BWA and WLAN applications would be destroyed.

Another problem with prior art similar to FIG. 2, is that these device generally possess highly reactive circuit impedances by virtue of the device selection, design, materials, assembly methods or, a combination thereof. Reactive device impedances have the undesirable effect of causing intolerable coupling loss and distortion of data and modulated radio frequency signals. Hence, prior art similar to FIG. 2 severely limits usable data rates and bandwidths, greatly increasing the chances of bit error rates. Another problem with prior art similar to FIG. 2, is a general inability to meet the data, electrical power and telephony performance and configuration requirements of many emerging broadband wireless access (BWA) and wireless local area networks (WLAN).

Commercially available BWA and WLAN communication equipment generally conform to domestic and international standards. These standards include but are not limited to IEEE 802.3af for power over Ethernet applications utilizing four twisted pair (category 5) cabling. In these BWA and WLAN applications, two of the twisted pair are used for high speed Ethernet data transfer (10/100 base-T), the remaining two pair are used to provide electrical power to a radio or, bridge.

Other BWA and WLAN applications utilize coaxial cable for Ethernet data or, modulated radio frequency in addition to electrical power transfer between equipment and would comply with applicable domestic or, international standards.

Given the demands of BWA and WLAN applications, high energy transient protection devices must be capable of providing low signal coupling losses, low signal distortion and low loss coupling of electrical power yet also provide effective high energy transient protection of the communication and electrical power equipment. Prior art generally possess intolerable signal coupling losses, signal distortion, electrical power coupling losses or, a combination thereof. Lastly, the transient protection performance of prior art is generally inadequate to protect much of the BWA and WLAN communication equipment currently in application from being damage by high energy transient events such as lightning.

In these respects, the transient protector for wireless communications equipment according to the present invention substantially departs from the conventional concepts and designs of the prior art, and in so doing provides an apparatus primarily developed for the purpose of providing high energy transient protection to electronics processing high speed, complex data and modulated radio frequency signals while providing improved signal coupling and reduced signal distortion. Another purpose is for providing high energy transient protection of electrical power equipment while providing improved power coupling. Another purpose is for providing high energy transient protection of telephony equipment while providing improved signal coupling losses and reduced signal distortion.

### SUMMARY OF THE INVENTION

In view of the foregoing disadvantages inherent in the known types of transient protection device now present in the prior art, the present invention provides a new transient protector for wireless communications equipment construction wherein the same can be utilized for providing high energy transient protection to electronics processing high speed, complex data and modulated radio frequency signals while providing improved signal coupling and reduced signal distortion. Another purpose is for providing high energy transient protection of electrical power equipment while providing improved power coupling. Another purpose is for providing high energy transient protection of telephony equipment while providing improved signal coupling and reduced signal distortion.

The general purpose of the present invention, which will be described subsequently in greater detail, is to provide a new transient protector for wireless communications equipment that has many of the advantages of the transient protection device mentioned heretofore and many novel features that result in a new transient protector for wireless communications equipment which is not anticipated, rendered obvious, suggested, or even implied by any of the prior art transient protection device, either alone or in any combination thereof.

To attain this, the present invention generally comprises a device having an electrical input interface and an electrical output interface, a circuit possessing transient conditioning electronic components and having an electrical input and electrical output lies within the device, a first set of conductors within the device electrically couples the device input interface to the circuit input, a second set of conductors within the device electrically couples the circuit output to the device output interface.

The transformer is a ferro-magnetic device possessing two electrically isolated electrical conductors that are wound around the perimeter of a toroid made of ferro-magnetic material creating a device possessing four electrical ports, two of which are electrically isolated from the remaining two. The capacitor is a bidirectional electronic device possessing a first end and a second end. The first end and second end of the capacitor are separated by an electrical dielectric material.

The gas discharge tube is a bidirectional electronic device possessing a first end and a second end. The first end and second end of the gas discharge tube are separated by a ceramic or, glass cylinder containing a gas mixture that will ionize and conduct electrical current when an ionizing voltage is impressed across the first end and second end of the gas discharge tube.

The varistor is a bidirectional electronic device possessing a first end and a second end. The first end and second end of the varistor are separated by an electrical conductor possessing voltage dependant negative resistance properties.

The resistor is a bidirectional electronic device possessing a first end and a second end. The first end and second end of the resistor are separated by an electrically conductive material of fixed resistance. To facilitate applications requiring protection against current fault conditions, the resistor input and output may also be separated by crystalline polymer matrix that changes to an amorphous structure when heated.

The TVS diode is a unidirectional or, bidirectional electronic device possessing a first end and a second end. The first end and second end of the TVS diode are separated by an avalanche or, Schottky semiconductor junction. The interface is a device possessing two or more electrical ports arranged in an application specific mechanical configuration for the purposes of providing the user of the present invention a means of electrically coupling the user equipment to the electrical input and output of the present invention.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a transient protector for wireless communications equipment that will overcome the shortcomings of prior art.

An object of the present invention is to provide a transient protector to protect electronic communication equipment that includes but is not limited to broadband wireless access and wireless local area network equipment whereby said transient protector provides improved protection against damage by high energy transient events such as lightning that is either directly or, indirectly coupled into communication equipment, data lines, power lines or, telephony lines.

Another object is to provide a transient protector for electronic communication equipment that includes but is not limited to broadband wireless access and wireless local area network equipment whereby said transient protector possesses improved signal coupling circuitry to couple complex high speed data signals, modulated radio frequency signals, electrical power and telephony signals or any combination thereof, that provides improved signal coupling performance and reduction in signal distortion.

Another object is to provide a transient protector for electronic communication equipment that includes but is not limited to broadband wireless access and wireless local area network equipment whereby said transient protector possesses improved signal coupling circuitry and that provides improved electrical isolation between data interfaces to prevent the coupling of transient energy between data interfaces.

Another object is to provide a transient protector for electronic communication equipment that includes but is not limited to broadband wireless access and wireless local area network equipment whereby said transient protector possesses improved signal and transient energy coupling circuitry that directly couples transient energy from data interfaces to a common ground or, other transient conditioning circuitry.

Another object is to provide a transient protector for electronic communication equipment that includes but is not limited to broadband wireless access and wireless local area network equipment whereby said transient protector possesses improved electrical power coupling circuitry that facilitates safe fusing in the event of electrical over current fault.

Another object is to provide a transient protector for electronic communication equipment that includes but is not limited to broadband wireless access and wireless local area network equipment whereby said transient protector possesses improved telephony circuitry that facilitates the coupling of telephony signals with low signal loss and distortion.

Another object is to provide a transient protector for electronic communication equipment that includes but is not limited to broadband wireless access and wireless local area network equipment whereby said transient protector possesses improved electrical power and telephony circuitry that directly couples transient energy from electrical power and telephony interfaces to a common ground.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a schematic diagram of a prior art transient protector circuit.

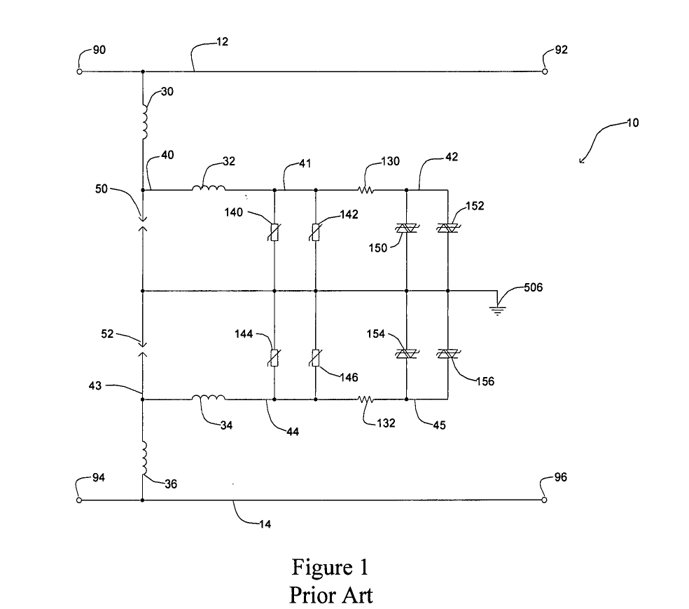

FIG. 2 is a schematic diagram of a prior art transient protector circuit.

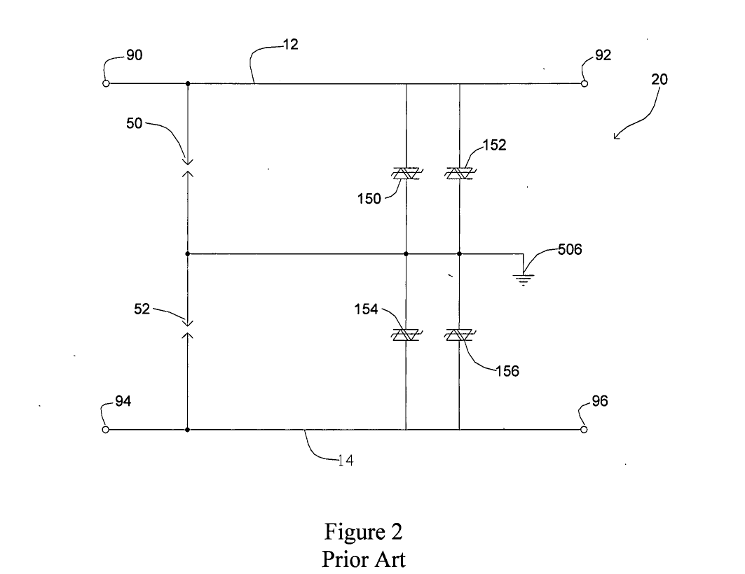

FIG. 3 is a schematic diagram of a first embodiment of the present invention.

FIG. 4 is a schematic diagram of a second embodiment of the present invention.

FIG. 5 is a functional block diagram of a conventional Ethernet network.

FIG. 6 is a functional block diagram of a conventional wireless local area network.

FIG. 7 is a functional block diagram of a conventional wireless local are network wherein the first and second embodiments of the present invention are employed.

### DESCRIPTION OF THE PREFERRED EMBODIMENT

Turning now descriptively to the drawings, in which similar reference characters denote similar elements throughout the several views, the attached figures illustrate a transient protector for communications equipment, which comprises a device having an electrical input interface and an electrical output interface, a circuit possessing signal, electrical power and transient conditioning electronic components and having an electrical input and electrical output lies within the device, a first set of conductors within the device electrically couples the device input interface to the circuit input, a second set of conductors within the device electrically couples the circuit output to the device output interface.

The transformer is a ferro-magnetic device possessing two electrically isolated electrical conductors that are wound around the perimeter of a toroid made of ferro-magnetic material creating a device possessing four electrical ports two of which are electrically isolated from the remaining two.

The capacitor is a bidirectional electronic device possessing a first end and a second end. The first end and second end of the capacitor are separated by an electrical dielectric material.

The gas discharge tube is a bidirectional electronic device possessing a first end and a second end. The first end and second end of the gas discharge tube are separated by a ceramic or, glass cylinder containing a gas mixture that will ionize and conduct electrical current when an ionizing voltage is impressed across the first end and second end of the gas discharge tube.

The varistor is a bidirectional electronic device possessing a first end and a second end. The first end and second end of the varistor are separated by an electrical conductor possessing voltage dependant negative resistance properties.

The resistor is a bidirectional electronic device possessing a first end and a second end. The first end and second end of the resistor are separated by an electrically conductive material of fixed resistance. To facilitate applications requiring protection against current fault conditions, the resistor input and output may also be separated by crystalline polymer matrix that changes to an amorphous structure when heated.

The TVS diode is a unidirectional or, bidirectional electronic device possessing a first end and a second end. The first end and second end of the TVS diode are separated by an avalanche or, Schottky semiconductor junction.

The interface is a device possessing one or more electrical ports arranged in an application specific mechanical configuration for the purposes of providing the user of the present invention a means of electrically coupling the user equipment to the electrical input and output of the present invention.

The transformer is a ferro-magnetic device possessing two electrically isolated electrical conductors that may include twisted bifilar wire, that are wound around the perimeter of a toroid made of ferro-magnetic material that may include Manganese-Zinc or, Nickel-Zinc, creating a device possessing four electrical ports two of which are electrically isolated from the remaining two. The transformer is a novel to the present invention. The transformers, together with the capacitors form the data coupling circuits of the present invention, a circuit that is also novel to the present invention. The transformer consists of two electrical conductors possessing a dielectric coating. The two conductors are formed into a helical pair. The helical pair of electrical conductors are wound several times around the perimeter of a toroid structure consisting of ferro-magnetic material to yield a transformer. The described transformer possesses a primary section consisting of one conductor of the helical pair possessing a pair of electrically coupled ports. The described transformer also possess a secondary section consisting of the second conductor of the helical pair and also possessing a pair of electrically coupled ports. The primary section of the transformer is electrically isolated from the secondary section of the transformer by virtue of the dielectric coating on the two conductors hence, electrically isolating the helical conductor pair.

A function of the described transformer is to couple desired complex, high speed data and modulated radio frequency signals while providing low signal coupling losses and low signal distortion.

Another function of the described transformer is to couple electrical power between the input and output data interfaces.

Another function of the described transformer is to prevent the coupling of undesirable transient energy between the primary and secondary conductors of the transformer.

Another function of the described transformer is to provide low impedance and direct coupling to ground or, other circuitry, transient energy present on either the primary or secondary conductors of the transformer.

Another function of the transformer is to prevent coupling of undesirable transient energy from coupling between the input and output data interfaces by virtue of the direct coupling of transient energy through the transformer's primary section and secondary to a ground or, other transient conditioning circuitry.

Another function of the transformer is to provide low loss, low distortion coupling of complex high speed data and modulated radio signals between the input and output data interfaces.

Another function of the transformer is to prevent coupling of undesirable transient energy between the input and output data interfaces by virtue of the electrical isolation between transformer's primary section and secondary section.

The capacitor is a bidirectional electronic device possessing a first end and a second end. The first end and second end of the capacitor are separated by an electrical dielectric material. The capacitor, together with the transformer form the data coupling circuit of the present invention, a circuit that is novel to the present invention. The capacitor employed in the present invention are commercially available devices consisting of two electrical conductors separated by a dielectric material that may include ceramic. The capacitors employed in the present invention may be surface mount, leaded or, of any other commercially available outline configuration. The capacitance value of those employed in the present invention generally falls within the range of 33 pico-Farads to 1 micro-Farads and possesses a dielectric breakdown voltage of 50 Volts minimum.

A function of the capacitor is to improve the high frequency response of the coupling circuit thereby reducing coupling losses and distortion to complex high speed data and modulated radio frequency signals.

Another function of the capacitor is to provide signal balance between the ports of the data coupling circuit to improve signal performance and reduce signal distortion.

Another function of the capacitor is to prevent the coupling of transient energy between the input and output interface ports by virtue of the low capacitance dielectric material that separates the capacitor's input from its output.

Another function of the capacitor is couple to common ground, undesirable signals that have parasitically coupled onto the electrical power and telephony circuit.

The gas discharge tube is a bidirectional electronic device possessing a first end and a second end. The first end and second end of the gas discharge tube are separated by a ceramic or, glass cylinder containing a gas mixture that will ionize and conduct electrical current when an ionizing voltage is impressed across the first end and second end of the gas discharge tube. The gas discharge forms part of the electrical power and telephony protection circuits of the present invention. The gas discharge tubes employed in the present invention are commercially available devices consisting of two electrical conductors separated by a ceramic or, glass cylinder containing a gas mixture that will ionize and conduct electrical current when an ionizing voltage is impressed across the first end and second end of the gas discharge tube. The gas discharge tubes employed in the present invention may be surface mount, leaded or, of any other commercially available outline configuration. The ionization voltage and current handling capabilities of gas discharge tubes employed in the present invention are selected to meet the application requirements of the present invention.

A function of the gas discharge tube as employed in the present invention is to couple high levels of transient energy from the input interface of the present invention to a common ground while limiting the voltage and energy level that is coupled to the data coupling, power and telephony protection circuits hence, preventing damage to those circuit components.

The varistor is a bidirectional electronic device possessing a first end and a second end. The first end and second end of the varistor are separated by an electrical conductor possessing voltage dependant negative resistance. The varistor forms part of the electrical power and telephony protection circuits of the present invention. The varistors employed in the present invention are commercially available devices consisting of two electrical conductors separated by a voltage dependant negative resistance material that may include Zinc oxide. The varistors employed in the present invention may be surface mount, leaded or, of any other commercially available outline configuration. The voltage and current handling capabilities of varistors employed in the present invention are selected to meet the application requirements of the present invention.

A function of the varistor as employed in the present invention is to couple high levels of transient energy from the input interface to a common ground while limiting the voltage and energy level that is coupled to the data coupling, power and telephony protection circuits hence, preventing damage to those circuit components.

The resistor is a bidirectional electronic device possessing a first end and a second end. The first end and second end of the resistor are separated by an electrically conductive material of fixed resistance. To facilitate applications requiring protection against current fault conditions, the resistor input and output may also be separated by crystalline polymer matrix that changes to an amorphous structure when heated. The resistor, together with the TVS diodes form part of the power and telephony protection circuits of the present invention. The resistors employed in the present invention are commercially available devices consisting of two electrical conductors separated by a resistive metal oxide material or, a crystalline polymer matrix material that changes to an amorphous structure when heated. The resistors employed in the present invention may be surface mount, leaded or, of any other commercially available outline configuration. The resistance values and power handling capability of the resistors employed in the present invention are being selected to meet the application requirements of the present invention.

A function of the resistor employed in the present invention is to limit the level of transient current that can be coupled from the varistors that form part of the power and telephony protection circuit to the TVS diodes that also form part of the power and telephony protection circuit hence, preventing damaging levels of transient current from being coupled through the TVS diodes.

Another function of the resistor employed in the present invention is to provide current fault protection for wireless communication equipment requiring such protection.

The TVS diode may be a unidirectional or, bidirectional electronic device possessing a first end and a second end. The first end and second end of the TVS diode are separated by an avalanche or, Schottky semiconductor junction. The TVS diode together with the resistor forms part of the power and telephony protection circuits of the present invention. The TVS diodes employed in the present invention are commercially available devices consisting of two electrical conductors separated by an avalanche or, Schottky diode junction. The TVS diodes employed in the present invention may be surface mount, leaded or, of any other commercially available outline configuration. The voltage and current handling capabilities of the TVS diodes employed in the present invention are be selected to meet the application requirements of the present invention.

A function of the TVS diode employed in the present invention is to couple moderate levels of transient energy to a common ground while limiting the voltage and energy level that is coupled to the output interface hence, preventing damage to communication equipment connected to the output interface of the present invention.

The interface is a device possessing one or more electrical ports arranged in an application specific mechanical configuration for the purposes of providing the user of the present invention a means of electrically coupling communication equipment to the electrical input and output of the present invention. The interface employed in the present invention provides a means for the present invention to electrically and mechanically coupled communication equipment to the present invention. The type of interface is application specific. Generally the interfaces used on this invention may consist of commercially available connectors such as RJ-45, RJ-8, terminal block, coaxial or, other type of connectors.

A function of interfaces employed in the present invention is to provide a means of electrically and mechanically coupling the present invention to communication equipment.

Another function of interfaces employed in the present invention is to provide a means of coupling high speed data, modulated radio frequency, electrical power and telephony signals between communication equipment and the present invention.

Another function of interfaces employed in the present invention is to provide a means of coupling undesirable transient energy to the present invention for conditioning.

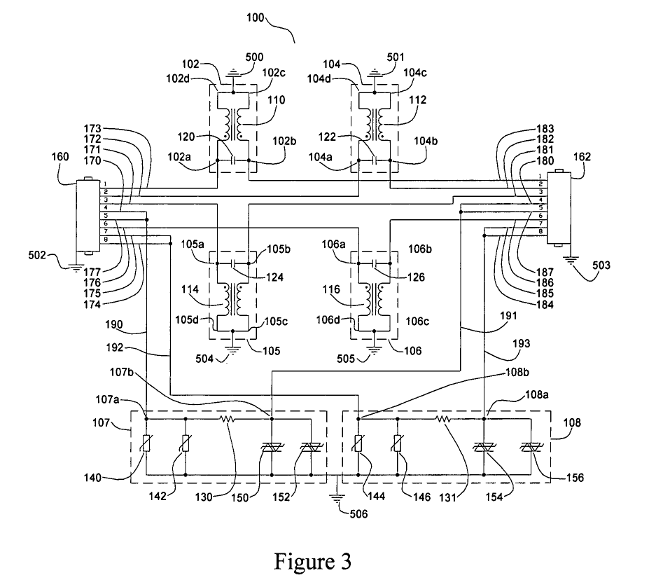

FIG. 3 represents a first preferred embodiment 100 of the present invention for wireless communications equipment. The first preferred embodiment 100 of the present invention is comprised of a first interface 160 possessing eight electrical ports J1-1 through J1-8 and a second interface 162 possessing eight electrical ports J2-1 through J2-8. The first interface 160 and the second interface 162 may possess an electrical shield that is coupled to a common ground 502, 503.

A first data coupling circuit 102 possessing a first port 102a, a second port 102b, a third port 102c and a fourth port 102d is comprised of a first capacitor 120 possessing a first end and a second end and a first transformer 110 possessing a first end, a second end, a third end and a fourth end. The first end of the first capacitor 120 is electrically coupled to the first end of the first transformer 110 and constitutes the first port 102a of the first data coupling circuit 102. The second end of the first capacitor is electrically coupled to the second end of the first transformer 110 and constitutes the second port 102b of the first data coupling circuit 102. The third end of the first transformer 110 constitutes the third port 102c of the first data coupling circuit 102. The fourth end of the first transformer 110 constitutes the fourth port 102d of the first data coupling circuit 102. The third port 102c and the fourth port 102d of the first data coupling circuit 102 are electrically coupled to a common ground 500. The first port 102a of the first data coupling circuit 102, is electrically coupled 173 to the first port J1-1 of the first interface 160. The second port 102b of the first data coupling circuit 102 is electrically coupled 183 to the first port J2-1 of the second interface 162.

A second data coupling circuit 104 possessing a first port 104a, a second port 104b, a third port 104c and a fourth port 104d is comprised of a first capacitor 122 possessing a first end and a second end and a first transformer 112 possessing a first end, a second end, a third end and a fourth end. The first end of the first capacitor 122 is electrically coupled to the first end of the first transformer 112 and constitutes the first port 104a of the first data coupling circuit 104. The second end of the first capacitor is electrically coupled to the second end of the first transformer 112 and constitutes the second port 104b of the first data coupling circuit 104. The third end of the first transformer 112 constitutes the third port 104c of the first data coupling circuit 104. The fourth end of the first transformer 112 constitutes the fourth port 104d of the first data coupling circuit 104. The third port 104c and the fourth port 104d of the first data coupling circuit 104 are electrically coupled to a common ground 501. The first port 104a of the first data coupling circuit 104 is electrically coupled 172 to the first port J1-2 of the first interface 160. The second port 104b of the first data coupling circuit 104 is electrically coupled 182 to the first port J2-2 of the second interface 162.

A third data coupling circuit 105 possessing a first port 105a, a second port 105b, a third port 105c and a fourth port 105d is comprised of a first capacitor 124 possessing a first end and a second end and a first transformer 114 possessing a first end, a second end, a third end and a fourth end. The first end of the first capacitor 124 is electrically coupled to the first end of the first transformer 114 and constitutes the first port 105a of the first data coupling circuit 105. The second end of the first capacitor is electrically coupled to the second end of the first transformer 115 and constitutes the second port 105b of the first data coupling circuit 105. The third end of the first transformer 114 constitutes the third port 105c of the first data coupling circuit 105. The fourth end of the first transformer 114 constitutes the fourth port 105d of the first data coupling circuit 105. The third port 105c and the fourth port 105d of the first data coupling circuit 105 are electrically coupled to a common ground 504. The first port 105a of the first data coupling circuit 105 is electrically coupled 171 to the first port J1-3 of the first interface 160. The second port 105b of the first data coupling circuit 105 is electrically coupled 181 to the first port J2-3 of the second interface 162.

A fourth data coupling circuit 106 possessing a first port 106a, a second port 106b, a third port 106c and a fourth port 106d is comprised of a first capacitor 126 possessing a first end and a second end and a first transformer 116 possessing a first end, a second end, a third end and a fourth end. The first end of the first capacitor 126 is electrically coupled to the first end of the first transformer 116 and constitutes the first port 106a of the first data coupling circuit 106. The second end of the first capacitor is electrically coupled to the second end of the first transformer 116 and constitutes the second port 106b of the first data coupling circuit 106. The third end of the first transformer 116 constitutes the third port 106c of the first data coupling circuit 106. The fourth end of the first transformer 116 constitutes the fourth port 106d of the first data coupling circuit 106. The third port 106c and the fourth port 106d of the first data coupling circuit 106 are electrically coupled to a common ground 505. The first port 106a of the first data coupling circuit 106 is electrically coupled 176 to the first port J1-6 of the first interface 160. The second port 106b of the first data coupling circuit 106 is electrically coupled 186 to the first port J2-6 of the second interface 162.

A first electrical power and telephony circuit 107 possessing a first port 107a and a second port 107b is comprised of a primary and secondary circuit.

The primary circuit is comprised of an at least first varistor and a second varistor 140, 142 each possessing a first end and a second end. The first ends of the first and second varistor 140, 142 are electrically coupled and constitute the first port 107a of the first electrical power and telephony circuit 107. The second ends of the first and second varistor 140, 142 are electrically coupled to a common ground 506.

The secondary circuit is comprised of an at least first TVS diode and a second TVS diode 150, 152 each possessing a first end and a second end. The first ends of the first and second TVS diode 150, 152 are electrically coupled and constitute the second port 107b of the first electrical power and telephony circuit 107. The second ends of the first and second TVS diode 150, 152 are electrically coupled to a common ground 506.

The secondary circuit is comprised of a first resistor 130 possessing a first end and a second end. The first end of the first resistor 130 is electrically coupled to the first port 107a of the first electrical power and telephony circuit 107. The second end of the first resistor 130 is electrically coupled to the second port 107b of the first electrical power and telephony circuit 107. The first port 107a of the first electrical power and telephony circuit 107 is electrically coupled 190, 170, 177 to the fourth J1-4 and fifth J1-5 ports of the first interface 160. The second port 107b of the first electrical power and telephony circuit 107 is electrically coupled 191, 180, 187 to the fourth J2-4 and fifth J2-5 ports of interface 162.

A second electrical power and telephony circuit 108 possessing a first port 108a and a second port 108b is comprised of a primary and secondary circuit.

The primary circuit is comprised of an at least first varistor and a second varistor 144, 146 each possessing a first end and a second end. The first ends of the first and second varistor 144, 146 are electrically coupled and constitute the first port 108a of the second electrical power and telephony circuit 108. The second ends of the first and second varistor 144, 146 are electrically coupled to a common ground 506.

The secondary circuit is comprised of an at least first TVS diode and a second TVS diode 154, 156 each possessing a first end and a second end. The first ends of the first and second TVS diode 154, 156 are electrically coupled and constitute the second port 108b of the second electrical power and telephony circuit 108. The second ends of the first and second TVS diode 154, 156 are electrically coupled to a common ground 506.

The secondary circuit is comprised of an at least first resistor 132 possessing a first end and a second end is a component of the secondary circuit. The first end of the second resistor 132 is electrically coupled to the first port 108a of the second electrical power and telephony circuit 108. The second end of the second resistor 132 is electrically coupled to the second port 108b of the second electrical power and telephony circuit 108. The first port 108a of the second electrical power and telephony circuit 108 is electrically coupled 192, 175, 174 to the seventh J1-7 and eighth J1-8 ports of the first interface 160. The second port 108b of the second electrical power and telephony circuit 108 is electrically coupled 193, 185, 184 to the seventh J2-7 and eight J2-8 ports of interface 162.

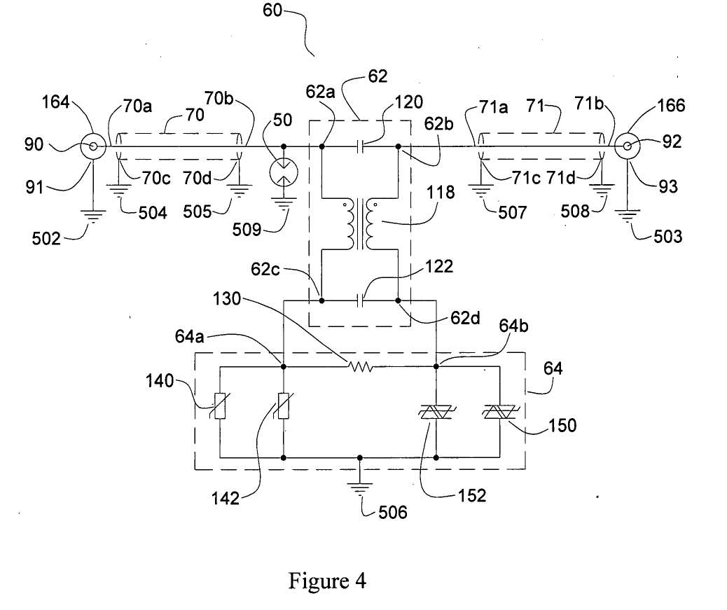

FIG. 4 represents second preferred embodiment 60 of the present invention for wireless communication equipment.

The second preferred embodiment of the present invention is comprised of a first coaxial interface 164 possessing an electrical inner center port 90, an outer electrical shield 91 and a dielectric material separating the electrical inner center port 90 from the outer electrical shield 91 of the first coaxial interface 164. A second coaxial interface 166 possessing an electrical inner center port 92 and an electrical shield 93 and a dielectric material separating the inner electrical center port 92 from the outer electrical shield 93 of the second coaxial interface 166. The electrical outer shield 91 of the first coaxial interface 164 is electrically coupled to a common ground 502. The electrical outer shield 93 of the second coaxial interface 166 is electrically coupled to a common ground 503. The first and second coaxial interfaces possess impedances defined by the requirements of the communication equipment to which this second embodiment of the present invention is applied.

A first electrical transmission line 70 that may be comprised of microstrip, stripline, coaxial or, similar topology and possessing an impedance defined by the requirements of the communication equipment to which this second embodiment of the present invention is applied, possesses a first port 70a, a second port 70b, a third port 70c and a fourth port. The third port 70c and fourth port 70d of the first transmission line 70 are electrically coupled to common grounds 504, 505. The first port 70a of the electrical transmission line is electrically coupled to the inner electrical center port 90 of the first coaxial interface 164. The second port 70b of the first electrical transmission line 70 is electrically coupled to the first port 62a of the data coupling circuit 62.

A second electrical transmission line 71 that may be comprised of microstrip, stripline, coaxial or, similar topology and possessing an impedance defined by the requirements of the communication equipment to which this second embodiment of the present invention is applied, possesses a first port 71a, a second port 71b, a third port 71c and a fourth port. The third port 71c and fourth port 71d of the first transmission line 71 are electrically coupled to common grounds 507, 508. The first port 71a of the electrical transmission line is electrically coupled to the inner electrical center port 92 of the first coaxial interface 166. The second port 71b of the first electrical transmission line 71 is electrically coupled to the second port 62b of the data coupling circuit 62.

A gas discharge tube 50 possesses a first end and a second end. The first end of the gas discharge tube 50 is electrically coupled to the first port 62a of the data coupling circuit 62. The second end of the gas discharge tube 50 is electrically coupled to a common ground 509.

A data coupling circuit 62 possessing a first port 62a, a second port 62b, a third port 62c and a fourth port 62d is comprised of a first capacitor 120 possessing a first end and a second end, a second capacitor 122 possessing a first end and a second end and a transformer 118 possessing a first end, a second end, a third end and a fourth end. The first end of the first capacitor 120 is electrically coupled to the first end of the transformer 118 and constitutes the first port 62a of the data coupling circuit 62. The second end of the first capacitor 120 is electrically coupled to the second end of the transformer 118 and constitutes the second port 62b of the data coupling circuit 62. The first end of the second capacitor 122 is electrically coupled to the third end of the transformer 118 and constitutes the third port 62c of the data coupling circuit. The second end of the second capacitor 122 is electrically coupled to the fourth end of the transformer 118 and constitutes the fourth port 62d of the data coupling circuit.

The electrical power and telephony circuit 64 possessing a first port 64a and a second port 64b. The first port 64a of the electrical power and telephony circuit 64 is electrically coupled to the third port 62c of the data coupling circuit 62. The second port 64b of the electrical power and telephony circuit 64 is electrically coupled to the fourth port 62d of the data coupling circuit 62. The electrical power and telephony circuit 64 is comprised of a primary and secondary circuit.

The primary circuit of the electrical power and telephony circuit 64 comprises of an at least first varistor and a second varistor 140, 142 each possessing a first and a second end. The first ends of the first and second varistors 140, 142 are electrically coupled and constitute the first port 64a of the electrical power and telephony circuit 64. The second ends of the first and second varistors 140, 142 are electrically coupled to a common ground 506.

The secondary circuit of the electrical power and telephony circuit 64 comprises of an at least first and a second TVS diode 150, 152 each possessing a first end and a second end. The first ends of the first and second TVS diode 150, 152 are electrically coupled and constitute the second port 64b of the electrical power and telephony circuit 64. The second ends of the first and second TVS diode 150, 152 are electrically coupled to a common ground 506.

A resistor 130 possessing a first end and a second end is a component of the secondary circuit. The first end of the resistor 130 is electrically coupled to the first port 64a of the electrical power and telephony circuit 64. The second end of the resistor 130 is electrically coupled to the second port 64b of the electrical power and telephony circuit 64.

Turning to discussion of high energy transient events. Clearly, high energy transient events that include lightning are statistical time domain events. Mathematically, all measurable time domain events can be transformed from the time domain to a frequency domain by applying Fourier analysis. When a measurable transient event such as lightning is transformed from the time domain to the frequency domain, it can be determined what frequency components possess the greatest levels of energy. Several professional and regulatory agencies have studied the statistics of high energy transient events that include lightning and in a effort to provide the telecommunications industry with some direction founded in science concerning transient protection, having developed several standards that define test conditions and methods that may be applied towards transient protection devices designed for various applications including wireless communications and specifically, test conditions and methods designed to test the ability of transient protection devices to protect various wireless equipment performing telephony, data and radio transmission functions. Of the various test conditions for transient protection devices that manifest the telecommunications industry several reign prominent and can be summarized in terms of transient waveforms of current or, voltage with defined rise and decay times. These waveforms include, but are not limited to current waveforms generally applied to wireless communication transient protection devices possessing 8/20 micro-Second rise/decay times and possessing between 3 kA and 20 kA of peak current and between 6 kV and 20 kV of peak voltage, current waveforms generally applied to wireless communication transient protection devices possessing 10/350 micro-Second rise/decay times and possessing between 1 kA to 5 kA of peak current and between 2 kV and 10 kV of peak voltage, current waveforms applied to Ethernet and wireless communication transient protection devices possessing 10/1000 micro-Second rise/decay times and possessing between 1 kA to 3 kA of peak current and between 2 kV and 6 kV of peak voltage.

The Fourier transform of these waveforms from the time domain to the frequency domain will generally demonstrate that the greatest levels of energy fall at frequencies below 100 kHz, with much of the energy in frequency components around 20 kHz.

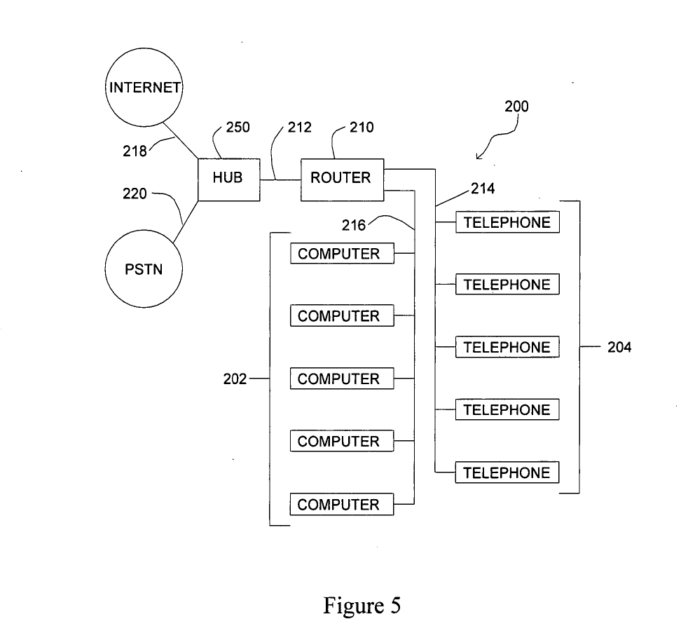

FIG. 5 sets fourth fundamentally, a conventional Ethernet network 200 that provides a means for data terminal equipment 202 that may include computers and telephony equipment 204 to communicate between each other locally (the Intranet) or, with other equipment in an external environment (the Internet/PSTN). The electrical coupling and data flow management between data terminal equipment of an Ethernet network to the Intranet and Internet is performed by electronic equipment that may include Ethernet routers 210 and bridges (hub) 250. In the preferred Ethernet configuration, the bridges and routers are located within a central location of a building. The electrical coupling 212, 214, 216 between hub 250, routers 210 and separate computer 202 and telephony 204 equipment (nodes) is accomplished using multiconductor or, coaxial cables that comply with IEEE 802.3 standards. The electrical coupling 218, 220 between the Ethernet bridges 250 and the Internet/PSTN access terminal is accomplished using multiconductor or, coaxial cables that comply with IEEE 802.3 standards. The electrical Internet/PSTN access terminals may also include access to an extended Intranet between buildings which may be provided by regional telephony services, regional television cable services, regional broadband wireless access services, regional wireless Internet provider or, wireless local area network (WLAN).

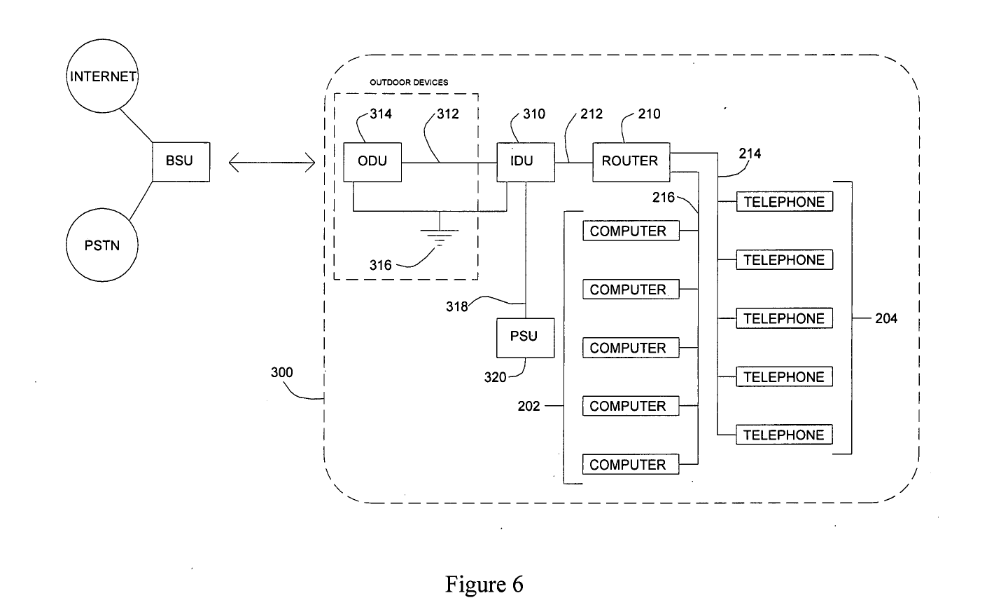

FIG. 6 sets fourth a fundamental a wireless local area network (WLAN) 300 that includes a first signal transmission device 312 possessing a first and a second end and preferably conforms to IEEE 802.3 standards. The first signal transmission device 312 couples signals that may include Ethernet data, modulated radio frequencies, electrical power and telephony between a first transceiver device 314 that is preferably a radio frequency transceiver with a baseband interface and a second transceiver 310 that is preferably a bridge that couples signals that may include Ethernet data, electrical power and telephony signals from external equipment. The first transceiver 314 is preferably an outdoor unit (ODU) that is mounted in an outside environment on a high structure, preferably a tall building or, a tower. The second transceiver 310 is preferably and indoor unit (IDU) that is mounted in an indoor environment within an equipment room. A first electrical power transmission device 318 that possess an at least two electrical conductors carry electrical power from an electrical power supply unit (PSU) 320 to the IDU 310. An at least second signal transmission device 212 that preferably conforms to IEEE 802.3 standards couples data signals that may include Ethernet data between the IDU 310 and an at least one Ethernet router 210 of an Ethernet network 216, 202. An at least third signal transmission device 214 that preferably conforms to telephony cabling standards couple telephony signals between the Ethernet router 210 and an telephony multiplexing equipment 204, 214.

It is preferable to mount the ODU 314 in an outdoor environment atop a high building or, tower. It is preferable to mount the IDU 310 in an indoor environment with an equipment room. The first signal transmission device 312, may extend 300 feet between the ODU 314 and IDU 310. A network system ground 316 may be established to provide a low potential reference for the wireless network 300 to couple various signals that may include transient energy to a low voltage (earth) potential point. Under this configuration, the ODU 314 and first signal transmission device 312 in portion or, in entirety are exposed to undesirable high energy transient events that may include lightning and electrical power surges that may couple undesirable and damaging transient energy into the entire wireless network 300 whereby transient energy is directly coupled or, induced into the ODU 314 circuitry, the first transmission device 312 and IDU 310 circuitry or, whereby transient energy is coupled into the ODU 314 circuitry, the first transmission device 312 or, IDU 310 circuitry through the network system ground 316 whereby the an electrically elevated ground potential condition has been induce by the transient event.

Thus, to prevent damage to the wireless network 300 an at least first transient protection device is physically located in close proximity to the ODU 314. The at least first transient protection device is coupled in series between the ODU 314 and the first end of the first signal transmission device 312. A second transient protection device is physically located in close proximity to the IDU 310. The second transient protection device is coupled in series between the IDU 310 and the second end of the first signal transmission device 312. Thus two transient protector devices of the first preferred embodiment or, the second preferred embodiment of the present invention are employed for a conventional wireless local area network (WLAN) 300.

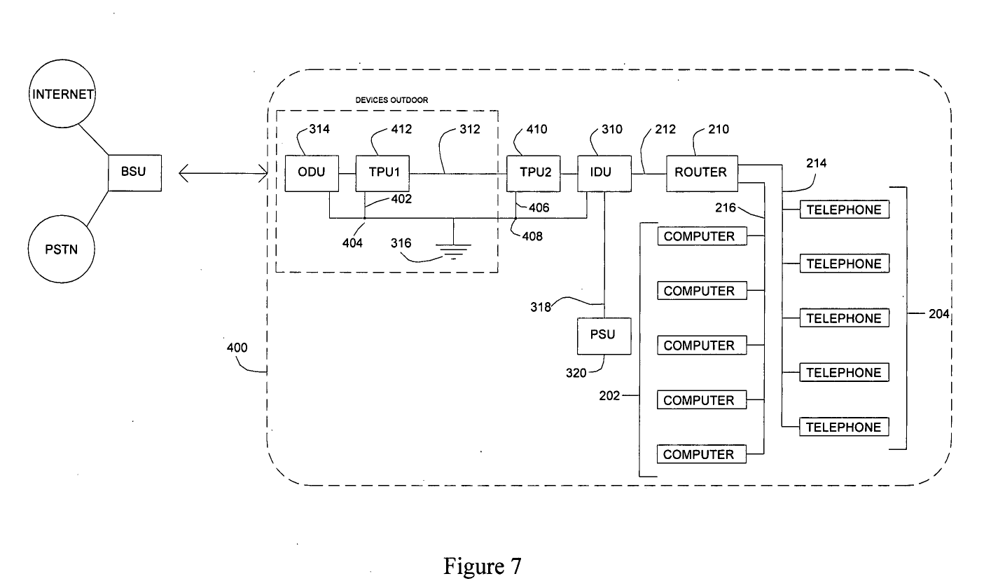

FIG. 7 functionally that sets fourths a conventional wireless local area network (WLAN) 400 wherein the first embodiment 100 (FIG. 3), of the present invention are employed. A first transient protector device (TPU1) 412 in accordance with the first embodiment of the present invention 100, is coupled in series between the ODU 314 and the first end of the first signal transmission device 312 possessing a first and a second end. A second transient protector device (TPU2) 410 in accordance with the first embodiment of the present invention 100 is coupled in series between the IDU 310 and the second end of the first signal transmission device 312.

Thus two transient protector devices 410, 412 of the first preferred embodiment of the present invention 100 are employed for a first embodiment conventional wireless local area network 400. The first transient protector device 412 located in close proximity to the ODU 314 mechanically and electrically couples a shield, a first, a second, a third and a forth pair of twisted conductors of the ODU 314 to the equipment side interface of the first transient protector device 412. The first transient protector device 412 mechanically and electrically couples a shield, a first, a second, a third and a fourth pair of twisted conductors of the first end of the first transmission device 312 to the line side interface of the first transient protector device 412. A first grounding conductor electrically 402 couples the first transient protector device 412 to a first point 404 on a system earth ground. A second transient protector device 410 located in close proximity to the IDU 310 mechanically and electrically couples a shield, a first, a second, a third and a forth pair of twisted conductors of the IDU 310 to the equipment side interface of the second transient protector device 410. The second transient protector device 410 mechanically and electrically couples a shield, a first, a second, a third and a fourth pair of twisted conductors of the second end of the first signal transmission device 312 to the line side interface of the second transient protector device 410. A second grounding conductor 406 electrically couples the second transient protector device 410 to a second point 408 on a system earth ground.

Thus, the ODU 314 and IDU 310 are electrically coupled together through a first transient protector device 412, a first transmission device 312 and a second transient protector device 410. Longitudinally balanced Rx data signals i.e. the signal current on each wire are of equal magnitude but of opposite phase are coupled between the ODU 314 and IDU 310 by a first pair of twisted conductors. The balanced transmission of signal aids in reducing undesirable crosstalk and signal loss. Similarly, a second pair of twisted conductors electrically couple longitudinally balanced Tx data signals between the IDU and ODU. A third pair of twisted conductors electrically couples electrical power that may include telephony TIP signal between the ODU 314 and IDU 310. A fourth pair of twisted conductors couples electrical power return that may include telephony RING signal between the ODU 314 and IDU 310.

Alternatively, FIG. 7 also functionally sets fourth a conventional wireless local area network (WLAN) 400 wherein the second preferred embodiment 60 (FIG. 4) of the present invention is employed. A first transient protector device (TPU1) 412 in accordance with the second embodiment of the present invention 60, is coupled in series between the ODU 314 and the first end of a first signal transmission device 312 possessing a first and a second end. The first signal transmission device 312 is preferably a coaxial cable possessing an inner electrical conductor, an outer electrical conductor and a dielectric material separating the inner and outer conductors. A second transient protector device (TPU2) 410 in accordance with the second embodiment of the present invention 60, is coupled in series between the IDU 310 and the second end of the first signal transmission device 312.

Thus, two transient protector devices 410, 412 of the second preferred embodiment of the present invention 60 are employed for a second embodiment of a conventional wireless local area network 400. A first transient protector device 412 located in close proximity to the ODU 314 mechanically and electrically couples the ODU 314 to the equipment side interface of the first transient protector 412. The first transient protector device 412 mechanically and electrically couples the first end of the first transmission device 312 to the line side interface of the first transient protector device 412. A first ground conductor 402 couples the first transient protector device 412 to a first point 404 on a system earth ground. A second transient protector device 410 located in close proximity to the IDU 310 mechanically and electrically couples IDU 310 to the equipment side interface of the second transient protector device 410. The second transient protector device 410 mechanically and electrically couples a second end of the first signal transmission device 312 to the line side interface of the second transient protector 410. A second ground conductor 406 electrically couples the second transient protector device 410 to a second point 408 on a system earth ground.

Thus, the ODU 314 and IDU 310 are coupled together through a first transient protection device 412, a first transmission device 312, and a second transient protection device 410. The inner conductor of the first signal transmission device 312 electrically couples signals that may include Ethernet data or, modulated radio frequencies, electrical power and telephony signals between the ODU 312 and IDU 310, coupling through the first transient protector 412 and the second transient protector 410. The outer conductor of the first signal transmission device 312 electrically couples the return of signals and electrical power and forms an electrical shield contiguously around and along the length of the first signal transmission device 312 to prevent undesirable coupling of electrical noise onto the inner conductor that may corrupt desirable signals.

Turning to FIG. 3 that sets fourth a transient protector device in accordance with the first preferred embodiment 100 of the present invention whereby a first interface (line side) 160 is coupled to a second interface (equipment side) 162 by a first 102, a second 102, a third 105 and a fourth 106 data coupling circuit. Under normal non-transient operating conditions, longitudinally balanced signals that may include receive (Rx) Ethernet data having data rates greater than 100 megabits per second (100 mbps) data are coupled into a first 102 and a second 104 data coupling circuit from either the first interface 160 (J1-1, J1-2) or, second interface 162 (J2-1, J2-2). Similarly, longit balanced signals that may include transmit (Tx) Ethernet data having data rates greater than 100 mbps are coupled into a third 105 and a fourth 106 data coupling circuit from either the first interface 160 (J1-3, J1-6) or, second interface 162 (J2-3, J2-6). coupling circuits 102, 104, 105, 106 are comprised of a capacitor (120, 122, 124 and 126 respectively) coupled across the first and second ends of a transformer (110, 112, 114 and 116 respectively) forming an efficient high pass filter possessing desirable broadband frequency performance. As the data coupling circuit 102, 104, 105, 106 each form a high pass filter possessing inductively and capacitively reactive components, at data rates ranging between 1 mbps to 10 mbps, the transformer efficiently couples the frequency spectrum of these data rates with little coupling loss or distortion to the data signal. The capacitor at these lower data rates appears as relatively high impedance to the data frequency spectrum, thus little signal coupling through the capacitor occurs below 90 MHz. At data rates ranging greater than 100 mbps, the capacitor appears as a relatively low impedance to the frequency spectrum of these higher data rate signals, thus the capacitor efficiently couples higher data signals with little coupling loss or signal distortion. On the other hand, the transformer appears as relatively high impedance to the frequency spectrum of data rates greater than 100 mbps. Thus little signal coupling occurs between the primary and secondary of the transformer at these higher data rates.

As the data coupling circuits 102, 104, 105, 106 constitutes a high pass filter comprised of inductively and capacitively reactive components, under non-transient operating conditions the signal coupling between the first port and second port of the data coupling circuits (102, 104, 105, 106) of frequencies between 175 kHz and 200 kHz is attenuated approximately 5 dB as a minimum and possess an approximate 12 dB per octave attenuation roll off from 200 kHz towards D.C.

Transient energy that is coupled into the first port or second port of a data coupling circuit (102, 104, 105, 106) will possess a high current content between D.C. and 20 kHz which will saturate the ferro-magnetic material toroid of the transformer as the transient current is coupled through one or, both of the conductors of the transformer to a common ground 500, 501, 504 and 505 respectively resulting in a reduction in inductance and hence, a reduction in impedance to transient frequency components from approximately 12 Ohms to approximately 0.03 Ohms. Therefore, much of the transient energy is coupled through the transformer to a common ground with little residual transient voltage drop across the transformer. The residual transient voltage that is present across the transformer is prevented from being coupled between the first port and second port of the data coupling circuit (102, 104, 105, 106) by the capacitor coupling across the first port and second port of the transformer that offers a high impedance of approximately 7,000 Ohms to the transient frequency components. Thus, the coupling attenuation of transient energy between the first port and second port of each data coupling circuit (102, 104, 105, 106) is greater than 40 dB.

The data coupling circuits 102, 104, 105, 106 require numerous considerations in capacitor selection (120, 122, 124 and 126 respectively) and transformer (110, 112, 114 and 116 respectively) construction. Capacitor value, material and geometry, bifilar conductor diameter, the number of bifilar conductor turns around the transformer toroid, the toroid geometry and toroid material all must be considered to establish the desired frequency performance and to prevent undesirable parasitics from creating undesirable excessive coupling loss and signal distortion. Preferably, the capacitor is a surface mount ceramic having a capacitance in the range of 33 pico-Farads to 1.0 micro-Farads and a working voltage of at least 50 Volts D.C.

The transformer toroid is preferrably constructed from Magnesium-Zinc or, Nickel-Zinc materials possessing an approximate geometry of 0.150 inch O.D., 0.09 inch I.D., and 0.05 inch thickness though smaller and larger geometries are employed to achieve the desired performance. Approximately 7 to 8 turns of preferably 24 AWG or, 28 AWG polymer coated bifilar wire is wound around the toroid. With due consideration given to components selection and construction the data coupling circuit (102, 104, 105, 106) will attain a frequency passband of 1 MHz to 3 GHz, possessing less than 0.6 dB of coupling loss, greater than 15 dB of return loss and less than 100 pico-Seconds of group delay across the passband.

Communication applications employing the first preferred embodiment of the present invention may require electrical power that range between −48 Volts to +24 Volts with associated currents that range between 0.35 to 3 Amperes direct current (D.C.). In addition, telephony signals may be coupled with the electrical power. Electrical power and telephony signals couple between a first interface 160 (line side) and a second interface 162 (equipment side) through a first electrical power and telephony circuit 107 and a second electrical power and telephony circuit 108 comprised of a primary and secondary circuit. The primary circuits are comprised of a shunt arrangement of varistors 140, 142 and 144, 146 respectively. The secondary circuits are comprised of a series resistor 130 and 132 respectively and an arrangement of shunt TVS diodes 150, 152 and 154, 156 respectively. The varistors and TVS diodes, possess parasitic capacitance and resistance. Hence, the first 107 and second 108 electrical power and telephony circuits possess a frequency response similar to that of a low pass filter. The upper frequency limit of the electrical power and telephony circuit generally above 150 kHz. Hence, electrical power, telephony and low data rate signals are coupled through the electrical power and telephony circuit with little distortion of signals and resistive power losses. The first 107 and second 108 electrical power and telephony circuits each possess a primary circuit and secondary circuit. Transient energy that is coupled into the first port of either or, both of the first 107 and second 108 electrical power and telephony circuit and hence, into the primary circuit that is comprised of a shunt varistor arrangement. The coupled transient energy will generally possess a high magnitude of voltage that may be between 1 kV to 50 KV. As these transient voltages are greater than the specified clamping voltage of the varistor, the varistor will change from a non-conducting state to a conducting state. Coupling much of the incident transient energy from the first port of the electrical power and telephony circuit to a common ground 506 over a period of time. During the period that the varistor is coupling transient energy, a voltage drop across the varistor that is a function of the specified clamping voltage of the varistor and the magnitude of transient current coupling through the varistor. Under high energy transient conditions, the transient voltage drop across the varistor may be as high as four times the specified clamping voltage of the varistor. Additionally, the varistor being a relatively slow device due to possessing parasitic shunt capacitance and shunt resistance, allows significant levels of residual transient energy to remain at the first port of the electrical power and telephony circuit that may be as long as several hundred micro-Seconds. Therefore, a secondary circuit comprised of a series resistor and shunt arrangement of TVS diode is employed to further reduce the level of residual transient energy that is coupled through the electrical power and telephony circuit. The series resistor of the secondary circuit limits the level of residual transient current that is coupled from the primary circuit of the electrical power and telephony circuit to the shunt TVS diode arrangement of the secondary circuit. The residual transient energy that couples through the resistor may possess a voltage level greater than the specified breakdown voltage of the TVS diodes, causing the TVS diodes to change from a non-conducting state to a conducting state. Hence, coupling much of the residual transient energy to a common ground 506 and limiting the level of residual transient energy that is coupled to the second port of the electrical power and telephony circuit.

Consideration must be given to the selection of components used in the first 107 and second 108 electrical power and telephony circuit. Selection of varistors (140, 142 and 144, 146 respectively) employed in the primary circuit of first and second electrical power and telephony circuits must consider varistor clamping voltage to prevent undesirable coupling of electrical power through the varistor under non-transient conditions. Varistor transient current handling capability must be considered to prevent undesirable damage to the varistor during coupling of transient current under transient conditions. Preferably, the varistors are selected that possess clamping voltages 3 to 5 Volts greater than the operating voltage and are rated for greater than 125 Amperes of transient current (8 uS/20 uS waveform).

The selection of TVS diodes (150, 152 and 154, 156 respectively) employed in the secondary circuit of the first and second electrical power and telephony circuit must consider TVS diode breakdown voltage to prevent undesirable coupling of electrical power through the TVS diode under non-transient conditions. TVS diode transient power handling capability must be considered undesirable damage to the TVS diodes during coupling of transient currents under transient conditions. Preferably, the TVS diodes are selected that possess breakdown voltages 3 to 5 Volts greater than the network operating voltage and are rated for greater than 500 Watts of transient power (10 uS/1000 uS waveform). Resistor (130 and 132 respectively) selection must take into consideration whether or, not current fault protection is required and the tolerance of the network to voltage drop across the transient protection device.

Consideration must also be given to the resistive material from which the resistor is made since certain materials are better than others at handling transient energy. If no current fault protection is required by the network, preferably a metal oxide resistor rated a 0.1 Ohms and 1 Watt is desirable. If current fault protection is require by the network then a commercially available polymer based resettable fuse with less than one Ohm of resistance, capable of safe operation within the power requirements of the network and possessing a trip current in accordance with network requirements is desirable.

Consideration must be given to the geometry and mounting of the varistors, TVS diode and resistor such that undesirable electrical parasitics are not introduced into the electrical power and telephony circuit that could adversely effect telephony and low data rate signals by introducing undesirable reduction in upper cutoff frequency, increased coupling losses or signal distortion. Preferably, commercially available surface mountable components are employed.

FIG. 4 that sets fourth a transient protector device in accordance with the second preferred embodiment 60 of the present invention whereby a first interface 164 (line side) is coupled to a second interface 166 (equipment side). The first interface 164 and second interface are 166 comprised of coaxial interfaces possessing an inner center conductor 90 and 92 respectively and an outer electrical shield 91 and 93 respectively. The outer shield of the first and second interfaces being electrically coupled to a common ground 502 and 503 respectively. Under normal non-transient conditions, Ethernet data or, modulated radio frequencies, electrical power and telephony is couple from the first interface 164 to the second interface 166 through the first transmission line 70, the data coupling circuit 62, the electrical power and telephony circuit 64 and the second transmission line 71. The data coupling circuit 62 forms an efficient high pass filter possessing desirable broadband frequency performance. As the data coupling circuit 62 is a high pass filter possessing inductively and capacitively reactive components, at data rates ranging between 1 mbps to 10 mbps or modulated radio frequencies below 90 MHz, the transformer 118 efficiently couples the data frequency spectrum with little coupling loss or distortion to the data signal. The capacitor 120 at these lower data rates appears as relatively high impedance to the data frequency spectrum, thus little signal coupling through the capacitor 120 occurs below 90 MHz. At data rates greater than 100 mbps or, modulated radio frequencies greater than 100 MHz, the capacitor 120 appears as a relatively low impedance to the data frequency spectrum, thus the capacitor 120 efficiently couples higher data signals with little coupling loss or signal distortion. On the other hand, the transformer 118 appears as relatively high impedance to the data frequency spectrum of data rates greater than 100 mbps or, modulated radio frequencies greater than 100 MHz. Thus little signal coupling occurs between the primary and secondary of the transformer 118 at these higher data rates and frequencies. As the data coupling circuit 62 is a high pass filter comprised of inductively and capacitively reactive components, under non-transient operating conditions the coupling between the first port 62a and second port 62b of the data coupling circuit 62 of frequencies between 175 kHz and 200 kHz is attenuated approximately 5 dB as a minimum and possess an approximate 12 dB per octave attenuation roll off from 200 kHz towards D.C.

Transient energy that is coupled into the first interface 164 will possess a voltage and current content between D.C. and 20 kHz. If the transient voltage coupling into the first interface 164 is of a magnitude to ionize the gas within the gas discharge tube 50, then the gas discharge tube will enter a state of conduction shunting much of the transient current and energy to common ground. Transient current that couples into the first port 62a of the data coupling circuit 62 as a result of gas discharge voltage drop or, otherwise, will couple through the primary side conductor of the transformer 118 to the first port 64a of the electrical power and telephony circuit 64 wherein the components associated with the electrical power and telephony circuit will enter a state of conduction shunting the transient energy to common ground and limiting the level of transient energy that will couple through the secondary side of the transformer 118 to the second port 62b of the data coupling circuit and hence the second interface 166. Furthermore, the transient current passing through the primary side of the transformer 118 will result in saturating the ferro-magnetic toroid of the transformer 118 resulting in a reduction in transformer 118 inductance and hence, a reduction in impedance to transient frequency components from approximately 12 Ohms to approximately 0.03 Ohms. Therefore, much of the transient energy is coupled through the primary side of the transformer 118 into the electrical power and telephony circuit 64 with little residual transient voltage drop across the primary of the transformer 118. The residual transient voltage that is present across the primary side conductor of the transformer 118 is prevented from being coupled between the first port 62a and second port 62b of the data coupling circuit 62 by the capacitor 120 coupling across the first end and second end of the transformer 118 that offers a high impedance of approximately 7,000 Ohms to the transient frequency components. Thus, the coupling attenuation of transient energy between the first port 62a and second port 62b of the data coupling circuit 62 and hence, the second interface 166, is greater than 40 dB.

The data coupling circuit 62 requires numerous considerations in capacitor 120, 122 selections and common mode transformer 118 constructions. Capacitor 120, 122 value, material, mounting and geometry, bifilar conductor diameter, the number of bifilar conductor turns around the transformer 118 toroid, the toroid geometry and toroid material all must be considered to establish the desired frequency performance and to prevent undesirable parasitics from creating undesirable excessive coupling loss and signal distortion.

Preferably, the capacitors 120, 122 are surface mount ceramic having a capacitance in the range of 33 pico-Farads to 1.0 micro-Farads and a working voltage of at least 50 Volts. The transformer 118 toroid is preferably constructed form Magnesium-Zinc or Nickel-Zinc ferrites possessing an approximate geometry of 0.15 inch O.D., 0.09 inch I.D., and 0.05 inch thickness though smaller and larger toroid geometries may be employed.

Approximately 4 to 8 turns of preferably 24 AWG or, 28 AWG polymer coated bifilar wire is wound around the toroid. With due consideration given to components selection and construction the data coupling circuit 62 will attain a frequency passband of 1 MHz to 3 GHz, possessing less than 0.6 dB of coupling loss, greater than 15 dB of return loss and less than 100 pico-Seconds of group delay across the passband.

Communication applications employing the second embodiment of the present invention may require electrical power that range between −48 Volts to +24 Volts with associated currents that range between 0.1 to 3 Amperes direct current (D.C.). In addition, telephony signals may be required. Under normal non-transient conditions, electrical power and telephony signals are coupled from the first interface 164 to the second interface 166 through the first transmission line 70, the data coupling circuit 62, the electrical power and telephony circuit 64 and the second transmission line 71. Because the transformer 118 used in the data coupling circuit 62 is a common mode transformer, the current form the electrical power will not cause the ferro-magnetic toroid of the transformer 118 to saturate. The electrical power and telephony circuit 64 is comprised of a primary and secondary circuit. The primary circuit is comprised of an arrangement of shunt varistors 140, 142. The secondary circuit is comprised of a series resistor 130 and shunt TVS diodes 150, 152. The varistors and TVS diodes possess parasitic capacitance and resistance. Hence, the electrical power and telephony circuit 64 possess a frequency response similar to a low pass filter. The upper frequency limit of the electrical power and telephony circuit 64 is generally 150 kHz. Hence, electrical power, telephony and low data rate signals are coupled through the electrical power and telephony circuit 64 with little distortion of signals and resistive power losses. Frequencies above 500 kHz are coupled through the shunt arrangements of varistors and TVS diodes of the electrical power and telephony circuit 64 to a common ground 506. Hence, a virtual signal ground is established.

Transient energy that couples into the first interface 164 through the first transmission line 70 and coupling to the first port 62a of the data coupling circuit 62 will generally possess a high magnitude of voltage that may be between 1 kV to 50 KV. As these transient voltages are greater than the specified ionization voltages for gas discharge tubes, the gas discharge tube 50 will enter a state of conduction shunting much of the transient current and energy to a common ground 509. However, because the gas discharge tube 50 is an inherently slow device possessing a relatively high ionization voltage and clamping voltage, significant levels of residual voltage and energy are present across the gas discharge tube 50 under a state of conduction.

Transient energy that is present at the first port 62a of the data coupling circuit as a result of gas discharge tube 50 transient voltage drop or, otherwise will couple from the first port 62a of the data coupling circuit 62 to the third port 62c of the data coupling circuit and hence couple to the first port 64a of the electrical power and telephony circuit. The magnitude of the transient voltage coupled to the first port 64a of the electrical power and telephony circuit 64 will generally be greater than the specified clamping voltage of the first and second varistors 140, 142. Therefore the varistors 140, 142 will change from a non-conducting state to conducting state. Coupling transient energy from the first port 64a of the electrical power and telephony circuit 64 to a common ground 506. During the period that the varistors 140, 142 are coupling transient energy, a voltage drop develops across the varistors 140, 142 that is a function of the specified clamping voltage of the varistors 140, 142 and the magnitude of the transient current coupling through the varistors 140, 142. Under high energy transient conditions, the transient voltage drop across the varistors 140, 142 may be as high as four times the specified clamping voltage of the varistor. Additionally, the varistors 140, 142 being a relatively slow device due to possessing parasitic shunt capacitance and shunt resistance, allows significant levels of residual transient energy to remain at the first port 64a of the electrical power and telephony circuit 64 that may be as long as several hundred micro-Seconds. Therefore, electrical power and telephony circuit 64 possess a secondary circuit comprised of a series resistor 130 and shunt arrangement of TVS diodes 150, 152 to reduce the level of residual transient energy that is coupled through the electrical power and telephony circuit. The series resistor 130 of the secondary circuit limits the level of residual transient current that is coupled from the primary circuit of the electrical power and telephony circuit 64 to the arrangement of shunt TVS diodes 150, 152 comprising the secondary circuit. The residual transient energy that couples through the resistor 130 may possess a voltage level greater than the specified breakdown voltage of the TVS diodes 150, 153, causing the TVS diodes 150, 152 to change from a non-conducting state to a conducting state coupling much of the residual transient energy to a common ground 506 and limiting the level of residual transient energy that is coupled to the second port 64b of the electrical power and telephony circuit 64. The greatly reduced levels of residual energy that exists on the second port 64b of the electrical power and telephony circuit 64 will be coupled through the fourth port 62d and second port 62b of the data coupling circuit 62, through the second transmission line 71 and coupled to the second interface 166.

Consideration must be given to the selection of components used in the electrical power and telephony circuit 64. Selection of varistors 140, 142 employed in the primary circuit of first and second electrical power and telephony circuit 64 must consider varistor clamping voltage to prevent undesirable coupling of electrical power through the varistor under non-transient conditions. Varistor transient current handling capability must be considered to prevent undesirable damage to the varistor during coupling of transient current under transient conditions. Preferably, the varistors 140, 142 are selected that possess clamping voltages 3 to 5 Volts greater than the operating voltage and are rated for greater than 125 Amperes of transient current (8 uS/20 uS waveform). The selection of TVS diodes 150, 152 employed in the secondary circuit of the first and second electrical power and telephony circuit 64 must consider TVS diode breakdown voltage to prevent undesirable coupling of electrical power through the TVS diode under non-transient conditions. TVS diode transient power handling capability must be considered undesirable damage to the TVS diodes during coupling of transient currents under transient conditions. Preferably, the TVS diodes 150, 152 are selected that possess breakdown voltages 3 to 5 Volts greater than the network operating voltage and are rated for greater than 1500 Watts of transient power (10 uS/1000 uS waveform). Resistor 130 selection must take into consideration whether or, not current fault protection is required and the tolerance of the network to voltage drop across the transient protection device. Consideration must also be given to the resistive material from which the resistor is made since certain materials are better than others at handling transient energy. If no current fault protection is required by the network, preferably a metal oxide resistor rated a 0.1 Ohms and 1 Watt is desirable. If current fault protection is require by the network then a commercially available polymer based resettable fuse with less than one Ohm of resistance, capable of safe operation within the power requirements of the network and possessing a trip current in accordance with network requirements is desirable.

Consideration must be given to the geometry and mounting of the varistors 140, 142, TVS diode 150, 152 and resistor 130 such that undesirable electrical parasitics are not introduced into the electrical power and telephony circuit 64 that could adversely effect telephony and low data rate signals by introducing undesirable reduction in upper cutoff frequency, increased coupling losses or signal distortion. Preferably, commercially available surface mountable components are employed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A transient protector for wireless communication equipment comprising of; an input path for receiving data, modulated or un-modulated RF signals, electrical power, telephony signals and transient energy; an output path for propagating the data, modulated or un-modulated RF signals, electrical power and telephony signals; a first apparatus coupled in series with the input path and output path, the means to couple data, modulated or un-modulated RF signals from the input path to the output path, the means to divert transient energy to ground, the means to isolate transient energy from the output path; an second apparatus coupled in series with the input path and output path, the means to divert electrical power and telephony signals from the input path to the output path, the means to divert a transient energy to ground.
a) The transient protector of claim 1, further comprising of an input interface; an output interface, a printed circuit-board, a first input transmission line, an at least second input transmission line, a first output transmission line, an at least second output transmission line.
b) The printed circuit-board of claim 1(a), further comprising of two parallel conductors separated by dielectric material.
c) The printed circuit-board of claim 1(b), wherein one conductor, the means for transmission lines of desired impedance.
d) The printed circuit-board of claim 1(b), wherein one conductor, the means for transmission line ground plane.
e) The printed circuit-board of claim 1(b), wherein one conductor, the means for mechanically mounting of devices, the means for electrically coupling devices.
f) The input interface of claim 1(a), further comprising of signal connectors or, printed circuit contact pads, the means to couple data, modulated or un-modulated RF signals, electrical power, telephony signals and transient energy into the transient protector.
g) The output interface of claim 1(a), further comprising of signal connectors or, printed circuit contact pads, the means to couple data, modulated or un-modulated RF signals, electrical power and telephony signals from the transient protector.
h) The first input transmission line of claim 1(a), the means to provide input impedance matching, the means to couple data, modulated or un-modulated RF signals and transient energy from the input interface.
i) The at least second input transmission line of claim 1(a), the means to provide input impedance matching, the means to couple electrical power, telephony signals and transient energy from the input interface.
j) The first output transmission line of claim 1(a), the means to provide output impedance matching, the means to couple data, modulated or un-modulated RF signals to the output interface.
k) The at least second output transmission line of claim 1(a), the means to provide output impedance matching, the means to couple electrical power, telephony signals to the output interface.
l) The first apparatus of claim 1, the means to coupling data, modulated and un-modulated RF signals from the first input transmission line to the first output transmission line, the means to provide substantial impedance matching, the means to divert transient energy from the input transmission line to ground, the means to isolate transient energy form the first output transmission line.
m) The first apparatus of claim 1, further comprising of a first end, a second end, a third end, a fourth end.
n) The first apparatus of claim 1, wherein the first end is coupled to the first input transmission line, wherein the second end is coupled to the first output transmission line, wherein the third end is coupled to ground, wherein the fourth end is coupled to ground.
o) The first apparatus of claim 1, further comprising a transmission line common mode transformer, the means to couple low data rate signals from the first input transmission line to the first output transmission line, the means to couple low frequency modulate or un-modulated RF signals from the first input transmission line to the first output transmission line, the means to provide substantial impedance matching, the means to divert transient energy from the first input transmission line, the means to isolate transient energy from the first output transmission line.
p) The transmission line common mode transformer of claim 1(o), further comprising a ferrite base toroid, a parallel pair of electrically isolated conductors of desired impedance wound around the perimeter of the ferrite toroid, the number of conductor turns around the toroid, the means for substantially establishing bandwidth.
q) The parallel pair of electrically isolated conductors of claim 1(p), wherein the first conductor of the conductor pair, comprising of a first end and a second end, the means to divert transient energy from the first input transmission line to ground.
r) The first conductor of claim 1(q), wherein the first conduct end constitutes the first end of the first apparatus, wherein the second conductor end constitutes the third end of the first apparatus.
s) The parallel pair of electrically isolated conductors of claim 1(p), wherein the second conductor of the conductor pair, comprising of a first end and a second end, the means to divert transient energy from the first output transmission line to ground.
t) The second conductor of claim 1(s), wherein the first conductor end constitutes the second end of the first apparatus, wherein the second conductor end constitutes the fourth end of the first apparatus.
u) The first apparatus of claim 1, further comprising a first capacitor, the means to couple high data rate signals, high frequency modulated or un-modulated RF signals from the first input transmission line to the first output transmission line, the means to provide substantial impedance matching, the means to isolated transient energy from the first output transmission line, the means to substantially establishing bandwidth.
v) The first capacitor of claim 1(u), comprising of a first end and a second end, wherein the first end of the first capacitor is coupled to the first end of the first apparatus, wherein the second end of the first capacitor is coupled to the second end of the first apparatus.
w) The second apparatus of claim 1, the means to divert electrical power, telephony signals and transient energy from the at least second input transmission line, the means to couple electrical power and telephony signals to the at least second output transmission line, the means to divert transient energy to ground, the means to limit transient energy, the means to interrupt electrical power under fault.
x) The second apparatus of claim 1, further comprising of a first end, a second end.
y) The second apparatus of claim 1, wherein the first end is coupled to the at least second input transmission line, wherein the second end is coupled to the at least second output transmission line.
z) The second apparatus of claim 1, wherein the means for diverting transient energy to ground is a varistor.
aa) The second apparatus of claim 1, wherein the means for diverting transient energy to ground is a diode.
bb) The second apparatus of claim 1, wherein the means for diverting electrical power, telephony signals and transient energy is a resistor.
cc) The second apparatus of claim 1, wherein the means for diverting electrical power, telephony circuits and transient energy is a plurality of conductors.

2. A transient protector for wireless communication equipment comprising: an input path for receiving data, modulated or un-modulated RF signals, electrical power, telephony signals and transient energy; an output path for propagating the data, modulated or un-modulated RF signals, electrical power and telephony signals; a surge protection device coupled to the first input path, the means to divert a portion transient energy to ground; a first apparatus coupled in series with the input path and output path, the means to couple data, modulated or un-modulated RF signals from the input path to the output path, the means to divert electrical power and telephony signals from the input path to the output path, the means to divert transient energy from the input path, the means to isolate transient energy from the output path; an second apparatus coupled to the first apparatus the means to divert electrical power and telephony signals from the input path to the output path, the means to divert a portion of transient energy to ground.
a) The transient protector of claim 2, further comprising of an input interface; an output interface, a printed circuit-board, an input transmission line, an output transmission line.
b) The printed circuit-board of claim 2(a), further comprising of two parallel conductors separated by dielectric material.
c) The printed circuit-board of claim 2(b), wherein one conductor, the means for transmission line of desired impedance.
d) The printed circuit-board of claim 2(b), wherein one conductor, the means for transmission line ground plane.
e) The printed circuit-board of claim 2(b), wherein one conductor, the means for mechanically mounting of devices, the means for electrically coupling devices.
f) The input interface of claim 2(a), further comprising of signal connectors of a desired impedance or, printed circuit contact pads, the means to couple data, modulated or un-modulated RF signals, electrical power, telephony signals and transient energy into the transient protector.
g) The output interface of claim 2(a), further comprising of signal connectors of a desired impedance or, printed circuit contact pads, the means to couple data, modulated or un-modulated RF signals, electrical power and telephony signals from the transient protector.
h) The input transmission line of claim 2(a), the means to provide input impedance matching; the means to couple data, modulated or un-modulated RF signals, electrical power, telephony signals and transient energy from the input interface.
i) The output transmission line of claim 2(a), the means to provide output impedance matching; the means to couple data, modulated or un-modulated RF signals, electrical power and telephony signals to the output interface.
j) The first apparatus of claim 2, the means to coupling data, modulated and un-modulated RF signals from the input transmission line to the output transmission line, the means to provide substantial impedance matching, the means to divert electrical power and telephony signals from the input transmission line to the output transmission line, the means to divert transient energy from the input transmission line, the means to isolate transient energy form the output transmission line.
k) The first apparatus of claim 2, further comprising of a first end, a second end, a third end, a fourth end.
l) The second apparatus of claim 2, the means to divert electrical power and telephony signals, the means to divert transient energy to ground, the means to limit transient energy, the means to interrupt electrical power under fault.
m) The second apparatus of claim 2, further comprising of a first end, a second end.
n) The first apparatus of claim 2, wherein the first end is coupled to the input transmission line, wherein the second end is coupled to the output transmission line, wherein the third end is coupled to the first end of the second apparatus, wherein the fourth end is coupled to the second end of the second apparatus.
o) The first apparatus of claim 2, further comprising a transmission line common mode transformer, the means to couple low data rate signals from the input transmission line to the output transmission line, the means to couple low frequency modulate or un-modulated RF signals from the input transmission line to the output transmission line, the means to provide substantial impedance matching, the means to divert current electrical power from the input transmission line to the output transmission line, the means to prevent saturation of ferrite toroid by direct current electrical power, the means to divert transient energy from the input transmission line, the means to isolate transient energy from the output transmission line.
p) The transmission line common mode transformer of claim 2(o), further comprising a ferrite base toroid, a parallel pair of electrically isolated conductors of desired impedance wound around the perimeter of the ferrite toroid, the number of conductor turns around the toroid, the means for substantially establishing bandwidth.
q) The parallel pair of electrically isolated conductors of claim 2(p), wherein the first conductor of the conductor pair, comprising of a first end and a second end, the means to divert electrical power, telephony signals and transient energy from the input transmission line.
r) The first conductor of claim 2(q), wherein the first conductor end constitutes the first end of the first apparatus, wherein the second conductor end constitutes the third end of the first apparatus.
s) The parallel pair of electrically isolated conductors of claim 2(p), wherein the second conductor of the conductor pair, comprising of a first end and a second end, the means to divert electrical power and telephony signals to the output transmission line.
t) The second conductor of claim 2(s), wherein the first conductor end constitutes the second conductor end of the first apparatus, wherein the second end constitutes the fourth end of the first apparatus.
u) The first apparatus of claim 2, further comprising a first capacitor, the means to couple high data rate signals, high frequency modulated or un-modulated RF signals from the input transmission line to the output transmission line, the means to provide substantial impedance matching, the means to isolated transient energy from the output transmission line, the means to substantially establishing bandwidth.
v) The first capacitor of claim 2(u), comprising of a first end and a second end, wherein the first end of the first capacitor is coupled to the first end of the first apparatus, wherein the second end of the first capacitor is coupled to the second end of the first apparatus.
w) The first apparatus of claim 2, further comprising of a second capacitor, the means to substantially establishing bandwidth, the means to provide substantial signal balance, the means to substantially reduce signal distortion, the means to provide substantial impedance matching.
x) The second capacitor of claim 2(w), comprising of a first end and a second end, wherein the first end of the first capacitor is coupled to the third end of the first apparatus, wherein the second end of the first capacitor is coupled to the fourth end of the first apparatus.
y) The second apparatus of claim 2, wherein the means for diverting transient energy to ground is a varistor.
z) The second apparatus of claim 2, wherein the means for diverting transient energy to ground is a diode.
aa) The second apparatus of claim 2, wherein the means for diverting electrical power, telephony signals and transient energy is a resistor.
bb) The second apparatus of claim 2, wherein the means for diverting electrical power, telephony circuits and transient energy is a plurality of conductors.
cc) The surge protection device of claim 2, wherein the means for diverting transient energy is a gas discharge tube, wherein the gas discharge tube is coupled across the input transmission line and ground.
dd) The gas discharge tube of claim 2(cc), the means to divert a substantial portion of transient energy from the input transmission line to ground.
